(19) United States
(12) Patent Application Publication
(10) Pub. No.: US 2016/0135609 A1
(43) Pub. Date: May 19, 2016

(54) SEMI-ABSORBENT, SEMI-RESISTANT, BREATHABLE FABRIC

(71) Applicant: WELSPUN INDIA LIMITED, Mumbai (IN)

(72) Inventor: Dipali Goenka, Mumbai (IN)

(21) Appl. No.: 15/004,960

(22) Filed: Jan. 24, 2016

Related U.S. Application Data
(62) Division of application No. 14/074,690, filed on Nov. 7, 2013.

(30) Foreign Application Priority Data
Jun. 4, 2013 (IN) 1948/MUM/2013

(51) Int. Cl. A47C 27/00; B32B 5/16; D06M 15/643; B32B 5/26; D06M 15/256; B32B 5/02; B32B 3/08

(52) U.S. Cl. CPC A47C 27/006; B32B 5/022; B32B 5/024; B32B 5/16; B32B 3/08; B32B 5/026; B32B 5/26; D06M 15/256; D06M 15/6436; D06M 2101/06

(57) ABSTRACT

A semi-absorbent, semi-resistant, breathable fabric includes a single-layer having a first, hydrophilic side that absorbs water, and a second, hydrophobic side; wherein the first, hydrophilic side of the single-layer fabric quickly spreads out a liquid that is absorbed laterally to a wider area such that the absorbed liquid does not seep or pass through to the second, hydrophobic side of the single-layer fabric under gravitational force. A method of making a semi-absorbent, semi-resistant, breathable fabric includes: subjecting a first side of a single-layer fabric to a hydrophilic amino functional polysiloxane softener; treating a second opposite side of the fabric with a fluorocarbon compound under low pressure such that the fluorocarbon compound penetrates no more than half of the fabric thickness; and drying and curing the fabric, preferably at a temperature of about 145° C. to 155° C. for about three minutes to about five minutes.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### FIELD OF THE INVENTION

The present invention generally relates to the field of textile material that has application in moisture management, breathability, and water resistance. In particular, the present invention relates to semi-absorbent, semi-resistant, breathable fabric.

### BACKGROUND OF THE INVENTION

In conventional textile fabrics used in a mattress pad, hosiery items and other apparels, the top layer comprises a normal fabric and a bottom layer generally contains waterproof laminated nonwoven fabrics. Poly wadding generally is provided in-between these to give a bulky and soft feel imparting comfort properties. During daily use, a liquid substance like tea, coffee, and soft drinks, or any other liquid, may accidentally be spilled onto or otherwise come into contact with the bed, whereupon the fitted sheet absorbs the same and the liquid passes through to the top layer of the mattress pad and further passes through the wadding layer, wherein it is entrapped above the bottom layer inside the wadding. This liquid remains inside the wadding layer and may gradually start giving off a pungent smell. Bacterial and fungus growth also may result, and dust mites may thrive, which causes allergens.

U.S. Pat. No. 5,735,145 discloses a multi-layer weft knit fabric for absorbing moisture and wicking it from a first fabric layer to a second layer, as well as a method for making the fabric. The multi-layer fabric includes a first hydrophobic layer and a second hydrophilic layer, with the layers being secured together by a series of courses forming spacer yarns, which maintain the fabric layers in a spaced relationship relative to each other. The spacer yarns are adapted to wick moisture from the hydrophobic layer to the hydrophilic layer. The spacer yarns are preferably knit-in or laid-in to the respective knit fabric layers, and a plastic water-resistant layer is secured proximate the hydrophilic fabric layer. A method of integrally knitting the multi-layer fabric on a circular knitting machine is also described. The weft knitted multilayer fabric is selected from polyester, nylon, and polypropylene.

U.S. Pat. No. 6,806,214 discloses a mattress cover including a composite fabric comprising a hydrophobic material and a hydrophilic material on both sides of a fabric layer, the composite fabric being a single layer including an inner exposed surface of the hydrophobic and hydrophilic materials that is predominantly the hydrophobic material which is polypropylene, and an outer surface of the hydrophobic and hydrophilic materials that is predominantly the hydrophilic material which is one of polyester and cotton, the fabric providing a one-way liquid transport system transporting liquid away from the inner surface towards the outer surface.

United States Patent Application Publication No. 2007/0261173 discloses a spacer fabric in combination with an infant mattress pad. The spacer fabric has three parts or components knitted together to form a fabric with two breathable outer fabric layers and a breathable cushioned middle defined by yarns interconnecting the two layers. The spacer fabric is incorporated into an infant mattress pad in order to create an infant safety and comfort system designed to help reduce the risk of sudden infant death syndrome (SIDS) and also to provide infants with enhanced comfort.

U.S. Pat. No. 6,277,770 discloses an allergen-barrier fabric comprising: a fabric substrate, woven from 0 to 45% continuous synthetic filament yarns and 55 to 100% natural or synthetic spun yarns, wherein the fabric provides a barrier to mite-induced allergen particles. The allergen-barrier fabric further comprises a fluoro-chemical finish on the fabric, wherein the finish provides protection against fluid stains.

U.S. Pat. No. 6,511,927 discloses a breathable and waterproof textile laminate, said laminate comprising a microporous membrane comprising a hydrophobic film having a plurality of pores of a size large enough to allow water vapor to pass there through but small enough to inhibit the passage of liquid water; a nonporous layer bonded to said microporous membrane, which is expanded polytetrafluoroethylene, with a first adhesive to protect the microporous membrane from contaminants, said nonporous layer comprising a hydrophilic material capable of allowing the diffusion of water vapor there through; and a fabric layer adhered to one of the microporous membrane and the nonporous layer with a second adhesive. One of the first and second adhesives comprises a hydrophilic adhesive and the other comprises a non-breathable discontinuous non hydrophilic adhesive. The four fabric layers are laminated with an ePTFE layer.

United States Patent Application Publication No. 2012/0276797 discloses a barrier fabric, which is selected from cotton textile and/or a mixture of cotton and polyester, with a nanofibrous layer for mechanical retention of organic substances. The barrier fabric is formed by a sandwich structure containing a basic material from unwoven fabric of “spun bond” type, to which at least one nanofibrous layer is arranged, selected from the group comprising a hydrophilic polymer, a hydrophobic polymer, or in the case of double-layer arrangement, a combination of the hydrophilic polymer in one layer and the hydrophobic polymer in the other layer. The nanofibrous layer is equipped with a protective covering layer, and the individual layers of the sandwich are connected to each other. The nanofibrous layer is used as a barrier against penetration of allergens produced by the dust mites through the upholstery material of mattresses, pillows, bedclothes or soft furnishings. The hydrophobic polymer material is selected from polyurethane or from PVDF fluoro-polymer, or from their co-polymers respectively. The nanofibrous layer is made from the hydrophilic polymer PA6 of the polyamide group.

In view of the foregoing, it is believed that a need exists for a fabric having properties of concurrent absorbency, breathability, and water resistance, thereby providing hygienic properties to the fabric and comfort to the user. One or more aspects and features of the present invention are believed to address such need.

### SUMMARY OF THE INVENTION

The present invention includes many aspects and features.

Accordingly, in an aspect of the invention, a fabric comprises a first surface on which a liquid is quickly absorbed and spread over a wide area such that the liquid does not percolate or pass through to the opposite side of the fabric under gravitational force. A related aspect relates to a process for manufacturing such a fabric.

In another aspect of the invention, a single layer fabric is breathable as well as semi-absorbent on one side, but semi-resistant on the other side, whereby the absorbency and breathability of the fabric ensures user comfort properties of the fabric and the property of not allowing the water to seep through the single-layer fabric imparts hygienic properties of the fabric.

In another aspect of the invention, a semi-absorbent, semi-resistant, breathable fabric comprises a single-layer having a first, hydrophilic side that absorbs water, and a second, hydrophobic side. The first, hydrophilic side of the single-layer fabric quickly spreads out a liquid that is absorbed laterally to a wider area such that the absorbed liquid does not seep through to the second, hydrophobic side of the single-layer fabric under gravitational force.

In a feature of this aspect, the fabric comprises natural fibers.

In a feature of this aspect, the fabric comprises synthetic fibers.

In a feature of this aspect, the fabric comprises regenerated fibers.

In another feature of this aspect, the fabric comprises a combination of one or more natural fibers, one or more synthetic fibers, and one or more regenerated fibers.

In a feature of this aspect, the fabric is woven.

In another feature, the fabric consists of a woven single-layer fabric.

In another feature, the fabric comprises a single layer of woven fabric comprising weft yarns and warp yarns, wherein each of the weft yarns and the warp yarns extends on both sides of the single layer of fabric and is hydrophilic on the first side and hydrophobic on the second side.

In another feature, the fabric comprises a single layer of woven fabric comprising weft yarns and warp yarns, wherein each of the weft yarns and the warp yarns includes at least a first extent that is hydrophilic and at least a second extent that is hydrophobic relative to the first extent.

In another feature, the fabric comprises a single layer of woven fabric comprising weft yarns and warp yarns, each of which has a uniform absorbency along its length, the hydrophilic and hydrophobic properties being imparted to the single layer of fabric after the fabric has been woven.

In another feature of this aspect, the thread count of the fabric is in the range of 120 TC to 1200 TC.

In a feature of this aspect, the yarn count of the fabric is in the range of 30 s count to 120 s count.

In another aspect, a method of fabricating a semi-absorbent, semi-resistant, breathable fabric comprises the steps of: (a) subjecting a first side of a single-layer fabric to hydrophilic amino functional polysiloxane softener; (b) treating a second, opposite side of the fabric with a fluorocarbon compound under low pressure such that the fluorocarbon compound does not penetrate more than 50% of the fabric thickness; and (c) drying and curing the fabric to obtain the semi-absorbent, semi-resistant, breathable fabric.

In a feature of this aspect, step (c) comprises drying and curing at a temperature range of 145° C. to 155° C. for a time range of between three minutes and five minutes.

In a feature of this aspect, the fluorocarbon compound comprises; (i) a fluorocarbon emulsion, and (ii) a paste consisting of an acrylic cross linking polymer; urea; a handle modifier and softener; a synthetic thickening agent; a fixing agent; an antifoaming agent; a liquor ammonia; and water.

In a feature of this aspect, the fluorocarbon compound comprises: (i) a fluorocarbon emulsion, and (ii) a paste comprising 10% by weight of an acrylic cross linking polymer; 3% by weight of urea; 2% by weight of a handle modifier and softener; 1.8% by weight of a synthetic thickening agent; 0.5% by weight of a fixing agent; 0.5% by fabric of an antifoaming agent; 1% by weight of a liquor ammonia; and 81.2% by weight of water.

In a feature of this aspect, the ratio by weight of fluorocarbon emulsion to the paste is 25:75.

Additional aspects include a mattress pad, pillow, bed sheet, comforter, mattress, apparel, sportswear, industrial fabrics, and geotextiles, each made with the semi-absorbent, semi-resistant, breathable fabric in accordance with one or more of the foregoing aspects and features; and methods of making such a mattress pad, pillow, bed sheet, comforter, mattress, apparel, sportswear, industrial fabrics, and geotextiles.

In yet another aspect, a textile product, such as a mattress pad, comprises: a single layer of woven fabric; a layer of wadding; and a nonwoven fabric defining an enclosure in which the wadding is contained. The single layer of fabric comprises a hydrophilic side and an oppositely facing hydrophobic side, with the single layer of fabric being stitched to the enclosure in covering relation to a top side of the enclosure, and with the hydrophilic side of the single layer of fabric facing away from the enclosure and the hydrophobic side facing the enclosure. Liquid that may be spilled onto or otherwise come into contact with the top side of the mattress pad is absorbed by the hydrophilic side of the single layer of fabric on the top side of the mattress pad, spreads across the hydrophilic top side of the mattress pad, and does not seep through to the hydrophobic area of the single layer of fabric or to the wadding layer.

In a feature, the nonwoven fabric is waterproof or water resistant. In an alternative feature, the nonwoven fabric is not waterproof or water resistant.

In another feature, the mattress pad further comprises a skirt fabric or edge fabric stitched to the enclosure.

In another feature, the single layer of fabric comprises a breathable, woven fabric comprising warp and weft yarns, each of the yarns including at least a first extent that is hydrophilic and at least a second extent that is hydrophobic relative to the first extent.

In another aspect of the invention, a mattress pad comprises a layer of wadding located between a single layer of woven fabric on a top side of the mattress pad and a nonwoven fabric on a bottom side of the mattress pad. The single layer of fabric comprises a hydrophilic side facing away from the layer of wadding and an oppositely facing hydrophobic side facing toward the layer of wadding, the hydrophilic side of the single layer of fabric defining a top of the mattress pad.

In addition to the aforementioned aspects and features of the present invention, it should be noted that the present invention further encompasses the various logical combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings.

FIG. 1 is a schematic cross-sectional view of single-layer fabric in accordance with one or more preferred aspects and features of the present invention, wherein (a) indicates an upper, semi-absorbent side and (b) represents a lower, semi-resistant side, “semi-absorbent” and “semi-resistant” referring to the water absorbency of the respective sides of the fabric.

FIG. 2 is a schematic cross-sectional view of a single-layer fabric having a fabric construction showing an interlacement between warp yarn (c) and weft yarn (d), wherein it is demonstrated how the single-layer fabric provides a semi-absorbent area on one side (a) and a semi-resistant area on the other side (b).

FIG. 3 is a schematic cross-sectional view of the single-layer fabric of FIG. 2, wherein a liquid droplet (e) is shown coming into contact with the semi-absorbent side (a) on the upper fabric surface.

FIG. 4 is a schematic cross-sectional view of the single-layer fabric of FIG. 3, wherein the liquid droplet (e) has begun to spread laterally across the fabric, remaining only within the upper semi-absorbent portion of the fabric of side (a) without the liquid droplet (e) passing downward through the fabric seeping into the semi-resistant bottom portion of the fabric of side (b).

FIG. 5 is a schematic cross-sectional view of a mattress pad that includes the single-layer fabric of FIG. 1, wherein callout (f) denotes a wadding layer, callout (g) denotes normal nonwoven fabric, and callout (s) denotes a skirt fabric or edge fabric.

FIG. 6 is a schematic cross-sectional view of conventional mattress pad, wherein callout (i) denotes a conventional top layer fabric, callout (f) denotes a wadding layer, callout (e) denotes is a liquid drop passing through the top layer fabric into the wadding layer, callout (h) denotes a laminated waterproof fabric, callout (g) denotes a normal nonwoven fabric, and callout (s) denotes a skirt fabric or edge fabric.

### DETAILED DESCRIPTION

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Regarding applicability of 35 U.S.C. §112(f), no claim element is intended to be read in accordance with this statutory provision unless the explicit phrase “means for” or “step for” is actually used in such claim element, whereupon this statutory provision is intended to apply in the interpretation of such claim element.

Furthermore, it is important to note that, as used herein, “a” and “an” each generally denotes “at least one,” but does not exclude a plurality unless the contextual use dictates otherwise. Thus, reference to “a picnic basket having an apple” describes “a picnic basket having at least one apple” as well as “a picnic basket having apples.” In contrast, reference to “a picnic basket having a single apple” describes “a picnic basket having only one apple.”

When used herein to join a list of items, “or” denotes “at least one of the items,” but does not exclude a plurality of items of the list. Thus, reference to “a picnic basket having cheese or crackers” describes “a picnic basket having cheese without crackers”, “a picnic basket having crackers without cheese”, and “a picnic basket having both cheese and crackers.” Finally, when used herein to join a list of items, “and” denotes “all of the items of the list.” Thus, reference to “a picnic basket having cheese and crackers” describes “a picnic basket having cheese, wherein the picnic basket further has crackers,” as well as describes “a picnic basket having crackers, wherein the picnic basket further has cheese.”

Additionally, as used herein to modify “fabric”, the phrases “semi-absorbent” and “semi-resistant” refer to water absorbent and water resistant fabric properties of opposite sides of a fabric such that one side has a greater affinity for absorption than the other and a gradient exists with respect to water absorbency properties along the thickness of the fabric. Preferably the absorbent or water resistant properties of the fabric lies approximately in the range of 40% to 60%.

Referring now to the drawings, one or more preferred embodiments of the present invention are next described. The following description of one or more preferred embodiments is merely exemplary in nature and is in no way intended to implicitly limit the invention, its implementations, or uses.

FIG. 1 is a schematic cross-sectional view of a single layer of fabric in accordance with one or more preferred aspects and features of the present invention, wherein callout (a) indicates an upper, semi-absorbent side of the fabric and callout (b) represents a lower, semi-resistant side of the single layer of fabric. It will be appreciated from FIG. 1 that the two sides (a),(b) define the single layer of fabric, and that each side (a),(b) has a respective depth, with the combined depths defining the thickness of the single layer of fabric.

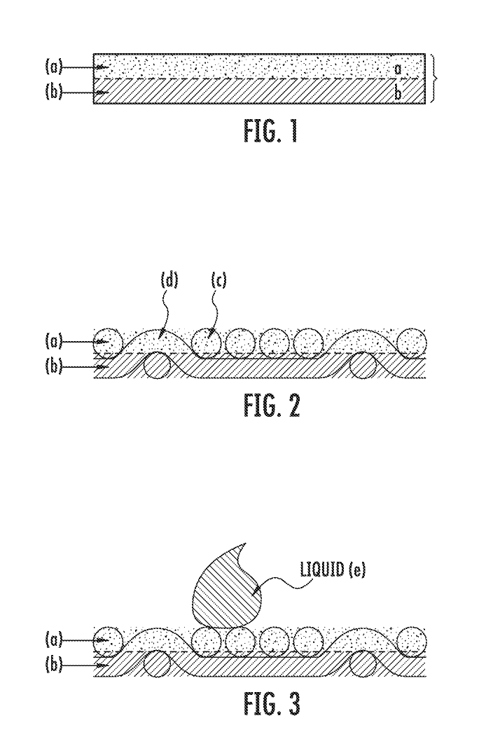

FIG. 2 is a schematic cross-sectional view of the single-layer fabric of FIG. 1, in which an exemplary construction of the fabric also is represented. The fabric construction shows an interlacement between warp yarns (c) and weft yarns (d) resulting from weaving of the yarns. Any conventional weaving procedure may be utilized; the fabric weave can be plain, satin, twill, dobby, jacquard, etc.

Preferably the fibers of the warp yarns and weft yarns are selected from natural fibers, synthetic fibers, or regenerated fibers, such as for example, cotton, rayon, polyester, or any other such fiber blends. Furthermore, the fibers preferably do not exhibit hydrophilic and hydrophobic properties; such properties of the fabric preferably are imparted through chemical processing that is performed on the fabric itself, described below, and not with the usage of hydrophilic or hydrophobic yarn.

In some embodiments, a yarn that is used in weaving the fabric prior to chemical processing of the fabric has a homogenous water-absorbency or water-resistant characteristic; after the chemical processing, the water-absorbency or water-resistant characteristic varies (alternates between being hydrophilic and hydrophobic, relatively speaking) along adjacent extents of the yarn.

The fabric further may have different characteristics depending on the material used and preferably is woven from between 120 TC to 1200 TC, and the finish can be done on the fabric made from 30 s yarn count to 120 s yarn count. In a preferred embodiment, the compact, single layer, woven fabric that is semi-absorbent, semi-resistant, and breathable is made from 100% cotton.

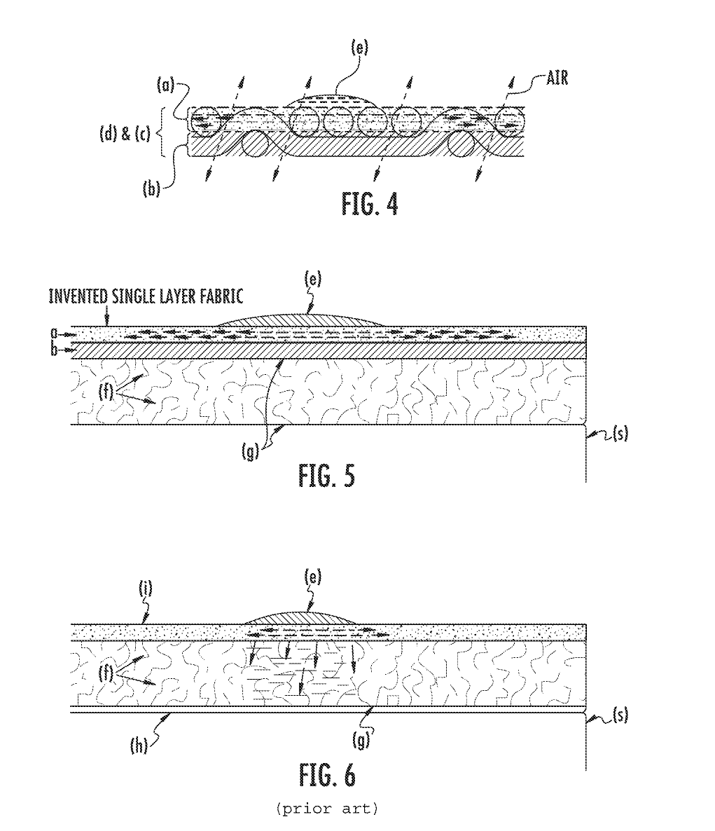

With reference now to FIGS. 3 and 4, desired absorption characteristics of the fabric are described. In this respect, FIG. 3 is a schematic cross-sectional view of the single-layer fabric of FIG. 2, wherein a liquid droplet (e) is shown coming into contact with the semi-absorbent side (a) on the upper fabric surface; and FIG. 4 is a schematic cross-sectional view of the single-layer fabric of FIG. 3, wherein the liquid droplet (e) has begun to spread laterally across the fabric, remaining only within the upper semi-absorbent portion of the fabric of side (a) without the liquid droplet (e) passing downward through the fabric seeping into the semi-resistant bottom portion of the fabric of side (b).

It thus will be appreciated that absorption of the liquid on the upper side (a) of the fabric results in the absorbed liquid being spread in the absorbent area of side (a). The hydrophobic area of the fabric consisting of side (b) that has been treated with fluorocarbon does not generally absorb the liquid relative to the hydrophilic side. As a result of this juxtaposition of side (a) and side (b), the fabric ensures that the liquid does not seep through from side (a) to side (b), with the liquid being absorbed and spreading only through the hydrophilic top area of the fabric on side (a). It will further be appreciated that the absorbent side (a) thereby protects the comfort characteristics of the fabric on side (b) from being impacted by a liquid seeping through to side (b).

FIG. 4 further illustrates the desired breathability of the fabric via the dashed arrows.

### Preferred Fabrication Methods

Aspects of the present invention also include fabrication methods for making semi-absorbent, semi-resistant, and breathable fabric. In preferred embodiments, a process for making such a fabric comprises: subjecting an upper side of the fabric to a hydrophilic amino functional siloxane softener; treating a back side of the fabric with a fluorocarbon compound under low pressure, wherein the fluorocarbon compound penetrates up to but not more than approximately 50% of the fabric thickness; and drying and curing of the fabric at a temperature range of 145° C. to 155° C. for a duration of time of between three minutes and five minutes for obtaining the desired product.

The silicone softeners are used in the process to impart hydrophilicity to the upper side of the fabric and are selected from Amino functional polysiloxanes.

The fluorocarbon compound is made by mixing two components, namely, (i) a fluorocarbon emulsion; and (ii) a paste consisting of an acrylic cross linking polymer (about 10% by weight); urea (about 3% by weight); a handle modifier and softener (about 2% by weight); a synthetic thickening agent (1.8% by weight); a fixing agent (0.5% by weight); an antifoaming agent (0.5% by weight); a liquor ammonia (1% by weight); and water (81.2% by weight). Depending on the requirement and fabric quality, the ratio for making fluorocarbon paste can vary from 10-40% of the fluorocarbon emulsion and 60-90% of the paste. Preferably, the two components are mixed in 25:75 ratio by weight before being applied to the fabric.

In some preferred embodiment, the fabric that is processed comprises a woven single-layer fabric of cotton yarns. In accordance therewith, the woven cotton fabric is subjected to singeing de-sizing, washing and processing through a conventional bleaching route, and mercerizing. This is followed by subjecting the upper side of the cotton fabric to hydrophilic softener treatment. The softener ensures a soft touch to the user, and the hydrophilic property ensures the absorbency of the upper side of the fabric even after finishing. The fabric is further subjected to fluorocarbon treatment at the back side of the cotton fabric such that the fluorocarbon compound penetrates up to approximately 50% of fabric thickness, or which penetration is about 0.1 mm to 0.2 mm. The fluorocarbons preferably are applied in the paste form through rotary printing machine or flat bed printing machine. The fluorocarbon paste can also be applied through coating or spray applications, etc. The fabric is dried and cured at a temperature range of 145° C. to 155° C. for a duration of about three to five minutes.

During the curing process the fluorocarbons are fixed on to the fabric which ensures the washing durability. The fluorocarbons penetrate up to approximately 50% of the thickness of the fabric, imparting the water resistant characteristics to the fabric on side (b). Side (a) is treated with hydrophilic softener and remains hydrophilic.

### Exemplary Fabrication Process

In a contemplated, exemplary method of manufacturing a preferred embodiment of the present invention, a single-layer woven cotton fabric having a thickness of between 0.2 mm to 0.4 mm is constructed with 60 s warp yarn and 80 s count weft yarn and with final thread count 400 TC. The woven cotton fabric is subjected to singeing de-sizing, washing and processing through conventional bleaching route, and mercerizing. This is followed by subjecting an upper side of the fabric to a hydrophilic amino functional polysiloxane softener treatment. A fluorocarbon is applied in the paste form through a rotary printing machine or flatbed printing machine on a back side of the fabric such that the fluorocarbon compound penetrates up to 0.1 mm to 0.2 mm thickness of the fabric. The fabric is dried and cured at a temperature of about 145° C. to about 155° C. for about three-to-five minutes.

### Implementations and Uses

FIG. 5 is a schematic cross-sectional view of a textile product, namely, a mattress pad, in which is utilized a single layer of fabric made in accordance with a preferred method of the invention. In particular, callouts (a) and (b) denote the single layer of fabric of FIG. 1. Additionally, callout (f) in FIG. 5 denotes a wadding layer, callout (g) denotes a conventional, nonwoven fabric, and callout (s) denotes a skirt fabric or edge fabric.

As illustrated, the single layer of fabric is stitched at the top side of the mattress pad with absorbent side (a) exposed, with the water resistant side (b) of the single layer of fabric facing the nonwoven fabric (g). If liquid (e) spills over the mattress pad, the liquid is absorbed and spreads across the absorbent area (a), and the liquid does not seep through the hydrophobic area (b) to the nonwoven fabric (g) adjacent area (b). Due to this, the wadding (f) and nonwoven fabric (g) remains dry and hygienic. In making the mattress pad, the wadding (f) is quilted with nonwoven fabric (g) on top and bottom sides. This quilted wadding then is attached to the single layer of fabric on all four sides along with the skirt.

In contrast to the mattress pad as shown in FIG. 5, a conventional waterproof mattress pad is constructed with normal fabric on the top side and nonwoven fabric at the back side. In this respect, FIG. 6 is a schematic cross-sectional view of a conventional mattress pad, wherein callout (i) denotes a conventional top layer fabric, callout (f) denotes a wadding layer, callout (e) denotes is a liquid drop passing through the top layer fabric into the wadding layer, callout (h) denotes a laminated waterproof fabric, callout (g) denotes a normal nonwoven fabric, and callout (s) denotes a skirt fabric or edge fabric. The liquid drop may be a liquid spilled, or may be perspiration of sweat from a person lying on the mattress pad, such as when sleeping. The normal fabric (i), wadding (f) and normal nonwoven fabric (g) is quilted together and attached to the laminated water resistant nonwoven fabric (h) from all four sides along with skirt. If any liquid (e) spills over the mattress pad, it gradually penetrates inside the mattress pad and gets entrapped inside the wadding layer (f) by the laminated waterproof fabric (h). After a certain period of time the entrapped liquid may give off a pungent smell and bacteria may grow inside the pad due to wet and damp conditions.

The advantages of the use of preferred embodiments of the invention in textile products will thus be apparent. The finished fabric of the instant invention is water absorbent at the upper side which allows the water to absorb and spread whereas the same will not pass through the other side. The said fabric is breathable also. The fabric of the present invention stops moisture before reaching fill and allows air flow for temperature comfort. It is anti-allergen and, when used in a mattress pad, provides superior mattress protection.

Moreover, preferred embodiments of the invention can be used not only in mattress pads, but also in pillows, sheets, comforters, mattresses, apparel, sportswear, industrial fabrics, and geotextiles, providing comfort to the user and imparting hygienic properties.

From the foregoing detailed description, it will be appreciated that a single layer of woven fabric in accordance with one or more preferred embodiment comprises weft yarns and warp yarns, wherein each of the weft yarns and the warp yarns extends on both sides of the single layer of fabric and is hydrophilic on the first side and hydrophobic on the second side.

Furthermore, it will be appreciated that a single layer of woven fabric in accordance with one or more preferred embodiment comprises weft yarns and warp yarns, wherein each of the weft yarns and the warp yarns includes at least a first extent that is hydrophilic and at least a second extent that is hydrophilic relative to the first extent.

It also will be appreciated that a single layer of woven fabric in accordance with one or more preferred embodiment comprises weft yarns and warp yarns, wherein the single layer of fabric is woven from weft yarns and warp yarns, each of which has a uniform absorbency along its length, the hydrophilic and hydrophobic properties being imparted to the single layer of fabric after the fabric has been woven.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention.

Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof.

1-15. (canceled)

16. A mattress pad, comprising:
(a) a single layer of fabric;
(b) a layer of wadding; and
(c) a nonwoven fabric defining an enclosure in which the wadding is contained;
(d) wherein the single layer of fabric comprises a hydrophilic side and an oppositely facing hydrophobic side, with the single layer of fabric being stitched to the enclosure in covering relation to a top side of the enclosure, and with the hydrophilic side of the single layer of fabric facing away from the enclosure and the hydrophobic side facing the enclosure, whereby liquid that is absorbed by the hydrophilic side of the single layer of fabric on the top side of the mattress pad spreads across the hydrophilic top side of the mattress pad and does not seep through to the hydrophobic area of the single layer of fabric or to the wadding layer.

17. The mattress pad of claim 16, further comprising a skirt fabric or edge fabric stitched to the enclosure.

18. The mattress pad of claim 16, wherein the single layer of fabric comprises a breathable, woven fabric comprising warp and weft yarns, each of the yarns including at least a first extent that is hydrophilic and at least a second extent that is hydrophobic relative to the first extent.

19-28. (canceled)

29. A mattress pad, comprising:
(a) a single layer of fabric;
(b) a layer of wadding; and
(c) a nonwoven fabric defining an enclosure in which the wadding is contained;
(d) wherein the single layer of fabric comprises a semi-absorbent side and a semi-resistant side, the two sides defining a single layer of the fabric, wherein each side has a respective depth, with the combined depths of the sides defining the thickness of the single layer of fabric, and wherein a gradient exists with respect to water absorbency properties along the thickness of the single layer of fabric.

30. The mattress pad of claim 29, wherein for each said yarn, alternating extents thereof are hydrophilic and hydrophobic.

31. The mattress pad of claim 29, wherein each said yarn comprises natural fibers, synthetic fibers, regenerated fibers, or combination thereof.

32. The mattress pad of claim 29, wherein the single-layer fabric is knitted.

33. The mattress pad of claim 29, wherein the single-layer fabric is woven.

34. The mattress pad of claim 33, wherein the single-layer fabric is woven from weft yarns and warp yarns, each of which has a uniform absorbency along its length, the hydrophilic and hydrophobic properties being imparted to the single-layer fabric after the fabric has been woven.

35. The mattress pad of claim 29, further comprising a skirt fabric or edge fabric stitched to the enclosure.

36. A mattress pad, comprising:
(a) a single layer of fabric;
(b) a layer of wadding; and
(c) a nonwoven fabric defining an enclosure in which the wadding is contained;
(d) wherein the single layer of fabric comprises a fabric construction of yarns extending on and collectively defining first and second opposite sides of the single-layer fabric, wherein for each said yarn, an extent thereof extending on and defining part of the first side of the single layer of fabric is hydrophilic, and an extent thereof extending on and defining part of the second side of the single layer of fabric is hydrophobic.

37. The mattress pad of claim 36, wherein for each said yarn, alternating extents thereof are hydrophilic and hydrophobic.

38. The mattress pad of claim 36, wherein each said yarn comprises natural fibers, synthetic fibers, regenerated fibers, or combination thereof.

39. The mattress pad of claim 36, wherein the fabric is woven.

40. The mattress pad of claim 39, wherein the single layer of fabric is woven from weft yarns and warp yarns, each of which has a uniform absorbency along its length, the hydrophilic and hydrophobic properties being imparted to the single-layer fabric after the fabric has been woven.

41. The mattress pad of claim 36, further comprising a skirt fabric or edge fabric stitched to the enclosure.

42. The mattress pad of claim 16, wherein the single layer of fabric comprises a breathable, woven fabric comprising warp and weft yarns, each yarn comprising alternating extents that are hydrophilic and hydrophobic.

43. The mattress pad of claim 16, wherein the single layer of fabric comprises a breathable fabric of woven yarns, each yarn comprising natural fibers, synthetic fibers, regenerated fibers, or combination thereof.

44. The mattress pad of claim 16, wherein the single layer of fabric is knitted.

45. The mattress pad of claim 16, wherein the single layer of fabric is woven from weft yarns and warp yarns, each of which has a uniform absorbency along its length, the hydrophilic and hydrophobic properties being imparted to the single layer of fabric after the fabric has been woven.
